(19) United States
(12) Patent Application Publication
(10) Pub. No.: US 2003/0050391 A1
(43) Pub. Date: Mar. 13, 2003

(54) Clay pigeons

(76) Inventors: Stanley Briers Gladders, Nottinghamshire (GB); Royston Esler Starkey, Worcestershire (GB)

Correspondence Address: Andrew R Basile, Young & Basile, Suite 624, 3001 West Big Beaver Road, Troy, MI, 48084-3107, US

(21) Appl. No.: 10/149,511

(22) PCT Filed: Dec. 11, 2000
(86) PCT No.: PCT/GB00/04748

(51) Int. Cl. C08J 3/00; C08K 3/00; C08L 81/00

(52) U.S. Cl. 524/609; 264/122

(57) ABSTRACT

A method of making clay pigeons is disclosed involving the step of compacting a dry powder comprising an inorganic filler comprising more than 50% by weight calcium carbonate and a binder. Also disclosed is a dry pressed pitchless clay pigeon.

This invention relates to clay pigeons.

In the sport of clay pigeon shooting targets (known as “clay pigeons” or “clays”) are flung into the air by a launching device (known as a “trap”) and a participant in the sport attempts to shoot the moving target using a shotgun. On impact of shot, the target is intended to break up.

Clay pigeons are conventionally manufactured using a hot moulding process in which milled limestone and hot pitch are moulded together, the pitch comprising approximately 20-40% by weight. Handling hot pitch has health and safety implications for workers making the clay pigeons.

One problem with competitive clay pigeon shooting is that sometimes an impact from a single shot will not be sufficient to cause the target to break up fully and this can lead to dispute over whether a clay pigeon has been hit or not. Ideally a clay pigeon should disintegrate even if hit by just one shot. This ideal is not normally met. At the same time the clay pigeon should be strong enough not to disintegrate in transport or when flung from the trap.

A further problem is the quantity of material that is left after a major clay pigeon shooting event. Every clay pigeon that goes up comes down to ground somewhere, either intact or in pieces. Approximately 350 million clay pigeons are sold per annum in the United Kingdom alone, and this represents a lot of material strewn on the ground (equivalent to approximately 3,500 tonnes per annum). The fact that the clay pigeons, if not hit or if only glancingly hit, leave large sized debris means that the material of the clay pigeons resists degradation for some time. The pitch present in the clay pigeons further impedes degradation.

Additionally, pitch tars have been classified as potential or actual carcinogens in some jurisdictions and there is a risk of contaminating ground waters with run off where there is a large quantity of clay pigeon debris, for example at shooting grounds.

U.S. Pat. No. 5,649,807 disclosed the manufacture of clays pigeons comprising at least 50% by weight clay, and 5-50% calcium containing additive (which could be limestone powder) which reduces the drying shrinkage of the (wet) clay. A plasticity-improving component such as a lignosulphonate could also be used. Clay pigeons are made from this mixture by pressing the mixture in a mould and removing them while still in a plastic (wet) state. Because the moulded clay pigeon is still wet careful handling to remove the clay pigeon from the mould is required. Even so such a process will cause problems in the reproducibility of

The clay pigeon may be made by a process in which the inorganic filler and binder are mixed as a slip and spray dried to form the dry powder.

The invention is illustrated by way of example in the following.

Calcium carbonate, clay, and lignosulphonate and a plasticiser were mixed with sufficient water to form a slip but not so much as to require excessive energy costs in drying and ball milled for four hours.

The calcium carbonate (supplied by Omya UK, Dorking, Surrey, England [similar grades available from Gurney Slade Lime and Stone Company Limited, Bath, England]) was 98.4% pure with a specific gravity of 2.7 and a particle size fine enough that less than 0.1% was retained on a 125 micron sieve.

The clay (supplied by ECC International Ltd. Cornwall England) had the composition (in wt %):

| | |
|---|---|
| SiO₂ | 54% |
| Fe₃O₄ | 1.4% |
| TiO₂ | 1.2% |
| K₂O | 3.1% |
| Al₂O₃ | 40.3% |
| Surface Area (BET) | 41 |

The lignosulphonate used was a modified softwood lignosulphonate with calcium ions (available from Borregaard UK Ltd. of Warrington, Cheshire, England).

The plasticiser was a polyglycol having a molecular weight of 1500 (available from Hoechst as product number IOPF205605).

A typical recipe by weight for the slip is:

| | |
|---|---|
| Water | 37.4% |
| Calcium carbonate | 45% |
| Clay | 11% |
| Lignosulphonate | 5.5% |
| Plasticiser | 1.1% |

It has also been suggested that since the previous deflocculating effect causes the mineral to become very finely divided, that these more discrete particles are retained when the mineral is recrystallised. (Though clearly the recrystallisation conditions will have a pronounced effect on this phenomenon.) Subsequent application of a compaction force allows the lignin to form hard agglomerates due to an inactive film bonding system. Other binders that achieve the same end result can of course be used.

The resultant clay pigeon could be packed (or used) immediately on removal from the tool die. Pressing by this route produces clay pigeons having an extremely high uniformity of shape, dimensions, weight, and texture which therefore have relatively uniform flight characteristics. The following table compares dimensions of a conventional “mini” clay pigeon (nominal diameter 60 mm and nominal weight 35 grams) with ones made to the invention. It can be seen that a much more uniform product results.

| | | | Invention as |
|---|---|---|---|
| | | | percentage of |
| | Normal | To invention | normal |
| Diameter (mm) | | | |
| Mean | 59.92 | 60.59 | |
| Standard Deviation | 0.054 | 0.042 | 77.78% |
| Rim thickness (mm) | | | |
| Mean | 11.15 | 11.11 | |
| Standard Deviation | 0.18 | 0.043 | 23.89% |
| Centre thickness (mm) | | | |
| Mean | 2.66 | 1.78 | |
| Standard Deviation | 0.15 | 0.055 | 36.67% |
| Out of round (mm) | | | |
| Mean | 0.09 | 0.052 | 57.78% |
| Standard Deviation | 0.039 | 0.037 | |
| Mass (g) | | | |
| Mean | 33.86 | 35.99 | |
| Standard Deviation | 0.71 | 0.33 | 46.48% |

1. A method of making clay pigeons by the step of compacting a dry powder comprising an inorganic filler and a binder, the inorganic filer comprising greater than 50% by weight calcium carbonate particles characterised in that the binder comprises a lignosulphonate compound, and in that prior to compaction at room temperature the inorganic filler and lignosulphonate compound are mixed as an acqueous slurry and spray dried to form a free flowing uniform powder in which lignin is bonded to the surface of the calcium carbonate particles in a uniform layer, so that adjacent lignin covered surfaces have a strong affinity for each other.

2. A method of making clay pigeons as claimed in claim 1, in which the organic filler also comprises clay.

3. A method of making clay pigeons as claimed in any preceding claim in which a plasticiser forms part of the powder.

4. A dry pressed pitchless clay pigeon whenever produced by the method of claim 1.
